(19) United States
(12) Patent Application Publication
(10) Pub. No.: US 2006/0201365 A1
(43) Pub. Date: Sep. 14, 2006

(54) Method for the open-loop or closed-loop control of a process for the production of printed copies

(76) Inventors: Rudolf Naegele, Friedberg (DE); August Thoma, Bonstetten (DE)

Correspondence Address: CROWELL & MORING LLP;INTELLECTUAL PROPERTY GROUP, P.O. BOX 14300, WASHINGTON, DC, 20044-4300, US

(21) Appl. No.: 11/363,742

(22) Filed: Feb. 28, 2006

(30) Foreign Application Priority Data
Mar. 2, 2005 (DE) 10 2005 009 406.6

(51) Int. Cl. B41F 33/00

(52) U.S. Cl. 101/483

(57) ABSTRACT

A method for the open-loop or closed-loop control of a process for the production of printed copies, is disclosed. A printing material being printed and subsequently further processed in order to produce printed copies, the printing material being moved through at least one printing unit of a press in order to print a static or unchanging printed image. The printing material is printed with dynamic or changing open-loop or closed-loop control data, for this purpose the printing material being moved through at least one printing device synchronized with the, or each, printing unit, and the open-loop or closed-loop control data being read from or on the printing material and being used for the open-loop or closed-loop control of the printing process and/or further processing process.

This application claims the priority of German Patent Document No. 10 2005 009 406.6, filed Mar. 2, 2005, the disclosure of which is expressly incorporated by reference herein.

### BACKGROUND AND SUMMARY OF THE INVENTION

The invention relates to a method for the open-loop or closed-loop control of a process for the production of printed copies. Furthermore, the invention relates to a method for the open-loop or closed-loop control of a process during the production of printed copies and to a press.

German Patent Document No. DE 103 17 187 A1 discloses a method for transmitting data from a prepress stage to a press, the data being printed onto a printing material in the form of a bar code in a printing-plate-based printing unit of the press. The bar code printed onto the printing material can be read out by a barcode reader, so that the barcode data can be processed further in a control device of the press. According to DE 103 17 187 A1, control data are accordingly applied to the printing material as a barcode in the form of a static or unchanging printed image, this bar code being identical for all the printed copies to be produced or to be printed and therefore being static or unchanging. This static or unchanging bar code can be read out on a barcode reader and can be processed in a control device of the press.

Taking this as a starting point, the present invention is based on the object of providing a novel type of method for the open-loop or closed-loop control of a process for the production of printed copies and also a novel type of press.

According to the invention, the printing material is printed with dynamic or changing open-loop or closed-loop control data, for this purpose the printing material being moved through at least one printing device synchronized with the, or each, printing unit, and the open-loop or closed-loop control data being read from or on the printing material and being used for the open-loop or closed-loop control of the printing process and/or further processing process.

Accordingly, it is within the spirit of the present invention to print dynamic or changing open-loop or closed-loop control data onto the printing material. This results in completely novel open-loop and closed-loop control functionalities on a press during the production of printed copies.

According to a first advantageous development of the invention, identification data used in the identification of a printed copy are printed on the printing material as open-loop or closed-loop control data, the identification data being printed onto the printing material in such a way that each printed copy is assigned at least one individual item of identification data, the identification data printed onto the printing material being assigned event data in an open-loop or closed-loop control device and, on the basis of the assignment of the event data to the individual items of identification data, the further printing process and/or further processing process being subjected to open-loop or closed-loop control.

According to a second, alternative advantageous development of the invention, event data are printed onto the printing material as open-loop or closed-loop control data, the event data corresponding to events occurring during the printing process and/or further processing process, the event data being printed only on those printed copies during the printing of which an event relevant to the further printing process and/or further processing process occurs or has occurred and, on the basis of event data printed onto the printing material, the further printing process and/or further processing process being subjected to open-loop or closed-loop control.

Preferred developments of the invention emerge from the following description.

### BRIEF DESCRIPTION OF THE DRAWINGS

An exemplary embodiment of the invention, without being restricted hereto, will be explained in more detail by using the drawings, in which:

FIG. 1 shows a block diagram to illustrate a first embodiment of the method according to the invention for the open-loop or closed-loop control of a process for the production of printed copies, and

FIG. 2 shows a further block diagram to illustrate a second embodiment of the method according to the invention for the open-loop or closed-loop control of a process for the production of printed copies.

### DETAILED DESCRIPTION OF THE DRAWINGS

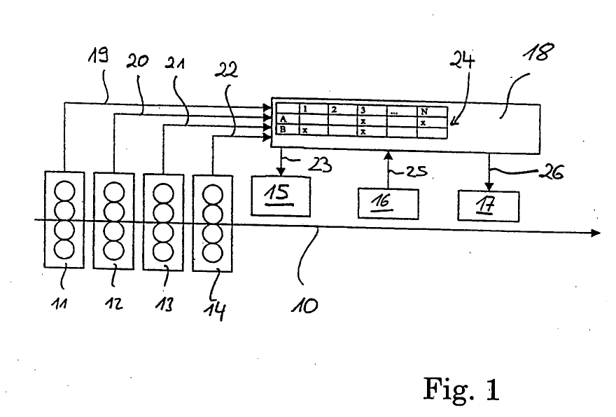

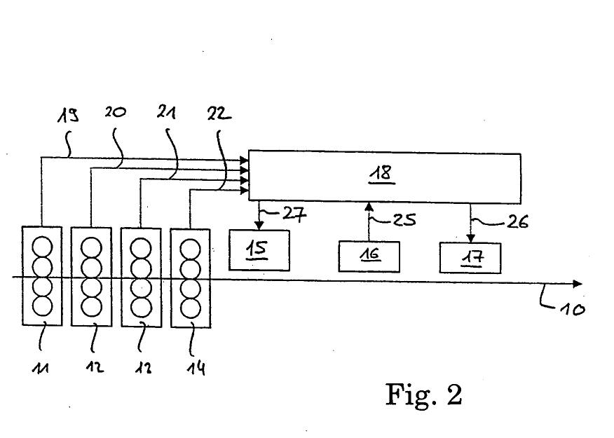

In the following text, the present invention will be described in greater detail with reference to FIGS. 1 and 2.

FIG. 1 illustrates in highly schematic form a process for the production of a printed copy, a web or else sheet printing material 10 being moved through printing units 11, 12, 13 and 14 of a press connected one after another in order to print the printing material 10 with a static or unchanging printed image.

In the case of autotypical overprinting, in each of the printing units 11, 12, 13 and 14 a printing ink, specifically one or more of the primary colors black, yellow, cyan and magenta and, if appropriate, one or more special colors, such as silver, is printed onto the printing material 10. It is obvious that the number of printing units 11 to 14 which are used for printing a static or unchanging printed image is variable. In the case of a black-and-white print, there is only one printing unit.

As already mentioned, the printing units 11, 12, 13 and 14 are used for printing the printing material 10 with a static or unchanging printed image, that is to say that, in the printing units 11 to 14, always the same printed image is applied to the printing material 10. The printing units 11, 12, 13 and 14 are constructed as printing-plate-based printing units, preferably as offset printing units. The printing units 11 to 14 can also operate in accordance with a gravure or flexographic printing method. The printing units 11 to 14 can also be constructed as digital offset printing units, which are marketed by the applicant under the product designation “DICOweb”.

In the spirit of the present invention, in addition to the static or unchanging printed image, the printing material 10 is printed with dynamic or changing open-loop or closed-loop control data. Accordingly, the open-loop or closed-loop control data are dynamic or changing printed images which, as distinct from the static printed images printed in the printing units 11 to 14, are characterized by variable or changing contents. In order to print the dynamic or changing open-loop or closed-loop control data, the printing material 10 is moved through at least one printing device 15 which, in the exemplary embodiment of FIG. 1, is connected in line with the printing units 11 to 14.

The open-loop or closed-loop control data are then read from or on the printing material 10 in the region of a reading device 16 in order on this basis to subject the further printing process and/or the further processing process to open-loop or closed-loop control. In the exemplary embodiment shown in FIG. 1, a device 17 is subjected to open-loop or closed-loop control on the basis of the dynamic or changing open-loop or closed-loop control data printed onto the printing material 10.

The reading device 16 and the device 17 to be subjected to open-loop or closed-loop control, just like the printing units 11 to 14 and the printing device 15, can be a constituent part of one and the same press. However, it is also possible for the reading device 16 and/or the device 17 to be subjected to open-loop or closed-loop control to be a constituent part of a further processing machine, which is separated physically from the press and/or which processes the printing material off-line and accordingly in a manner decoupled chronologically from the printing process in the press. The further processing machine can be, for example, a cutting machine or a sorting apparatus for inserts.

As can be gathered from FIG. 1, the printing units 11 to 14, the printing device 15, the reading device 16 and the device 17 to be subjected to closed-loop or open-loop control are connected to a control device 18. The printing units 11 to 14 transmit data about the printing process within the printing units 11 to 14 to the control device 18 in the direction of the arrows 19, 20, 21 and 22.

In the exemplary embodiment of FIG. 1, identification data used for the identification of a printed copy are printed onto the printing material 10 in the printing device 15 as open-loop or closed-loop control data, the identification data being printed onto the printing material 10 in such a way that each printed copy to be produced is assigned at least one individual item of identification data. The identification data can be a simple cardinal number, with which the printed copies can be distinguished from one another. The identification data printed onto the printing material 10 by the printing device 15 are preferably predefined by the control device 18 in the direction of the arrow 23. It is also possible for the printing device 15 to generate the identification data itself and to transmit them to the control device 18. In each case, the printing device 15 for printing the identification data is synchronized with the printing units 11 to 14, so that an individual item of identification data can be printed on each printed copy.

In the exemplary embodiment of FIG. 1, a static or unchanging printed image that is always the same is accordingly printed onto the printing material 10 in the printing units 11 to 14, identification data being printed onto the printing material 10 as dynamic or changing control data in the printing device 15 connected downstream of the printing units 11 to 14. Using these identification data, printed copies can be distinguished from one another.

As illustrated schematically in FIG. 1, the identification data printed onto the printing material 10 are assigned event data in the control device 18. Thus, FIG. 1 shows a table 24, in which the data “A” and “B” are event data and the data “1”, “2”, “3” . . . “N” are identification data. The event data “A” and “B” correspond to events which occur during the, printing process in the printing units 11, 12, 13 and 14. Thus, according to the table 24, the event “B” has occurred during the printing of the printed copy with the item of identification data “1”. During the printing of the printed copy with the item of identification data “2”, no event that is relevant to the further printing process or further processing process has occurred. Both the event “A” and the event “B” have occurred during the printing of the printed copy with the item of identification data “3”. During the printing of the printed copy with the item of identification data “N”, only the event “A” has occurred. The identification data printed onto the printing material are accordingly assigned in the control device 18 event data that are relevant to the further printing process and/or further processing process.

As already mentioned, the identification data are read in the reading device 16 and the result of the reading is transmitted to the control device 18 in the direction of the arrow 25. By means of a comparison of the item of identification data read with the table 24, an actuating signal for the device 17 can then be generated by the control device 18 and is transmitted to the device 17 in the direction of the arrow 26.

For instance, the device 17 can be what is known as a rejects diverter, which is opened and closed automatically by the control device 18 on the basis of the identification data printed onto the printing material 10 and the association between the event data and the identification data. For example, the event “B” can be an event that occurs in the printing units 11 to 14 which has a detrimental influence on the printing quality, printed copies to which this event is assigned being removed from the further processing process via the rejects diverter. In another exemplary embodiment, the device 17 can be, for example, a folding former, which is adjusted on the basis of the event “A”, which can correspond to a format change. In this case, this would mean that, in the case of the printed copies “3” and “N”, a format change takes place, on the basis of which the folding former has to be adjusted.

In the exemplary embodiment of FIG. 1, identification data which are used for the individualization of the printed copies are accordingly printed onto the printing material 10. These identification data are assigned in the control device 18 event data which, occurring during the printing process, correspond to events that are relevant to the further printing process and/or further processing process. By means of the association between identification data and event data, it is later possible, by reading the identification data, to determine the printed copies during the printing of which a relevant event has occurred, in order on this basis to subject the functioning or operation of the device 17 and therefore the further printing process and/or further processing process to open-loop or closed-loop control.

As distinct from the exemplary embodiment of FIG. 1, it is also possible, following the printing of the identification data, to also print event data onto the printing material 10, to be specific preferably in such a way that the event data are printed only onto those printed copies during the production of which an event relevant to the further printing process and/or further processing process has occurred. The printing of the event data is then carried out in printing devices, not illustrated, which are designed to print the identification data independently of the printing devices. In this case, at least one item of identification data would then be printed onto each printed copy but event data would be printed only onto the printed copies during which the respective event has occurred. In the reading device 16, the identification data and event data could then be read in order on this basis to subject the further printing process or a further processing process of the printed copy to open-loop or closed-loop control.

The two-stage printing of identification data and event data is preferably carried out in such a way that the identification data are applied to or printed onto the printing material during high-speed machine operation, and the event data during low-speed machine operation. The printing of the event data can be carried out off-line, for example in a further processing machine, the printing devices for printing the event data then being assigned to the further processing machine and synchronized with the latter.

With reference to FIG. 2, an alternative embodiment of the method according to the invention for the open-loop or closed-loop control of a process for the production of printed copies will be described, the same reference numbers being used for identical subassemblies in order to avoid unnecessary repetition. In the following text, only the details which distinguish the exemplary embodiment of FIG. 2 from the exemplary embodiment of FIG. 1 will be discussed.

In the exemplary embodiment of FIG. 2, event data are printed onto the printing material 10 in the printing device 15 as dynamic or changing open-loop or closed-loop control data. Thus, the printing units 11 to 14 again transmit data about the printing process to the control device 18 in the direction of the arrows 19 to 22, the control device 18 driving the printing device 15 in the direction of the arrow 27 in such a way that the printing device 15 prints an item of event data onto the printing material 10 only when an event relevant to the further printing process and/or further processing process has occurred during the printing. Accordingly, in the exemplary embodiment of FIG. 2, the printing material 10 is printed with event data in such a way that the same are assigned only to those printed copies during the printing of which the event relevant to the further printing process and/or further processing process has occurred. These variable or changing event data printed in the printing device 15 can then again be read in the reading device 16, on this basis the control device 18 generating an actuating signal for the device 17 of the press in the direction of the arrow 26. The printing device 15 is again synchronized to the printing sequence of the printing units 11 to 14, so that an item of event data can be printed onto each printed copy.

At this point, it should be pointed out that the variable or dynamic open-loop or closed-loop control data are preferably applied to the printing material 10 by using printing inks that are invisible to the human eye. Furthermore, the open-loop or closed-loop control data are preferably printed onto the printing material 10 outside what is known as the subject, that is to say outside a region printed in the printing units 11 to 14. This has the advantage that the open-loop or closed-loop control data cannot be perceived on the finished printed product by a consumer. It is recommended to print the open-loop or closed-loop control data onto the printing material 10 with fluorescent printing inks, which can then be read in appropriately matched reading devices 16.

As already mentioned, the printing units 11 to 14 for printing the static or unchanging printed image are designed as printing-plate-based printing units, in particular as offset printing units. The printing devices 15 for printing the dynamic or changing open-loop or closed-loop control data operate without a printing form and can be constructed as inkjet printing devices. The printing devices 15 used for applying the dynamic or changing open-loop or closed-loop control data can also be printing devices which are based on the principle of electrophotography, ionography, electro-coagulation or magnetography.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for an open-loop or closed-loop control of a process for production of printed copies, a printing material being printed and subsequently further processed in order to produce printed copies, the printing material being moved through at least one printing unit of a press in order to print a static or unchanging printed image, wherein the printing material is printed with dynamic or changing open-loop or closed-loop control data, for this purpose the printing material being moved through at least one printing device synchronized with the printing unit, and the open-loop or closed-loop control data being read from or on the printing material and being used for the open-loop or closed-loop control of a further printing process and/or further processing process.

2. The method according to claim 1, wherein identification data used in an identification of a printed copy are printed on the printing material as open-loop or closed-loop control data.

3. The method according to claim 2, wherein the identification data are printed onto the printing material in such a way that each printed copy is assigned at least one individual item of identification data.

4. The method according to claim 2, wherein the identification data printed onto the printing material are assigned event data in an open-loop or closed-loop control device, the event data corresponding to events during the further printing process and/or further processing process.

5. The method according to claim 4, wherein on a basis of an assignment of the event data to the identification data, the further printing process and/or further processing process are subjected to open-loop or closed-loop control.

6. The method according to claim 2, wherein following the printing of the identification data, the identification data are read from or on the printing material, and wherein event data are then additionally printed onto the printing material.

7. The method according to claim 6, wherein the event data are printed off-line of the identification data in a further processing machine constructed separately from the press.

8. The method according to claim 6, wherein the event data are printed onto the printing material in such a way that the event data are assigned only to those printed copies during the printing of which an event relevant to the further printing process and/or further processing process occurs or has occurred.

9. The method according to claim 6, wherein the printing of the identification data is carried out during a high-speed operation of the press, and the printing of the event data is carried out during a low-speed operation of the press or a further processing machine.

10. The method according to claim 1, wherein event data are printed onto the printing material as open-loop or closed-loop control data, the event data corresponding to events during the further printing process and/or further processing process.

11. The method according to claim 10, wherein the event data are printed only onto those printed copies during the printing of which an event relevant to the further printing process and/or further processing process occurs or has occurred.

12. The method according to claim 1, wherein the reading of the open-loop or closed loop control data is carried out off-line of the printing process in the press, in a further processing machine constructed separately.

13. The method according to claim 1, wherein the open-loop or closed-loop control data are printed with printing inks that are invisible to a human eye.

14. The method according to claim 13, wherein the printing inks are fluorescent printing inks.

15. The method according to claim 1, wherein the open-loop or closed-loop control data are printed onto the printing material outside a region printed in the printing unit.

16. A method for an open-loop or closed-loop control of a process during a production of printed copies, a printing material being printed and subsequently further processed in order to produce printed copies, wherein the printing material is printed with dynamic or changing open-loop or closed-loop control data, and wherein the open-loop or closed-loop control data are read from or on the printing material and are used for the open-loop or closed-loop control of the further printing process and/or further processing process.

17. A press, having at least one printing unit for printing a static or unchanging printed image onto a printing material, and having at least one printing device for printing at least one dynamic or changing printed image onto the printing material and an open-loop or closed-loop control device which subjects a further printing process and/or further processing process during a production of printed copies to open-loop or closed-loop control.

18. A method for printing a material, comprising the steps of:
printing a static image on the material by a printing unit;
printing dynamic open-loop or closed-loop control data on the printed material by a printing device;
reading the dynamic open-loop or closed-loop control data on the printing material; and
controlling a device by the read dynamic open-loop or closed-loop control data for performing a process on the printed material by the device.

19. The method according to claim 18, wherein the process is a printing process.

20. A press, comprising:
a printing unit, wherein the printing unit prints a static image;
a printing device, wherein the printing device prints dynamic open-loop or closed-loop control data;
a reading device, wherein the reading device reads the dynamic open-loop or closed-loop control data; and
a device controlled by the dynamic open-loop or closed-loop control data.
